(19) United States
(12) Patent Application Publication
(10) Pub. No.: US 2008/0174279 A1
(43) Pub. Date: Jul. 24, 2008

(54) BATTERY CHARGING SYSTEM AND METHOD THEREOF

(75) Inventors: XIANG-PING ZHOU, Shenzhen (CN); LIN-KUN DING, Shenzhen (CN); TSUNG-JEN CHUANG, Tu-Cheng (TW); SHIH-FANG WONG, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD, Shenzhen City (CN); HON HAI PRECISION INDUSTRY CO., LTD., TU-CHENG (TW)

(21) Appl. No.: 11/934,090

(22) Filed: Nov. 2, 2007

(30) Foreign Application Priority Data
Jan. 19, 2007 (CN) 200710200075.4

(51) Int. Cl. H02J 7/02; H01M 10/44

(52) U.S. Cl. 320/160

(57) ABSTRACT

A battery charging system for receiving an AC voltage and charging a rechargeable battery is provided herein. The battery charging system includes an adapter for rectifying an AC voltage into a first DC voltage; a controller for receiving a battery voltage of a rechargeable battery and outputting a control signal; and a DC switching convertor for converting the first DC voltage into a second DC voltage to recharge the rechargeable battery according to the control signal, wherein the second DC voltage changes according to the battery voltage. A charging method is also provided.

### BACKGROUND OF THE INVENTION

1. Field of the Invention

The present invention relates to battery charging systems and methods, and particularly to a battery charging system and method for recharging a rechargeable battery.

2. Description of Related Art

Electronic devices such as notebook computers, cellular phones, cordless telephones, mobile data terminals, etc are now very popular. These electronic devices typically include a rechargeable battery. There are two methods to recharge the rechargeable battery. A first method is to recharge the rechargeable battery externally, that is, removing the battery from the electronic device and placing the battery in an external charging device connected to an alternating current (AC) power source. A second method is to recharge the rechargeable battery within the electronic device, such as a notebook computer. In the second method, an adapter of the electronic device is designed to recharge the rechargeable battery, while simultaneously powering the electronic device.

FIG. 4 illustrates a conventional battery charging system 20 including an AC adapter 22 and a cellular phone 24 with a rechargeable battery 32. The battery charging system 20 recharges the rechargeable battery 32 in the above-described second method. The AC adapter 22 is for converting an AC input voltage into a direct current (DC) voltage, for example 12V, and outputting the DC voltage to the cellular phone 24. The AC adapter 22 usually includes an adapter (not shown in FIG. 4) for rectifying the AC input voltage into a first DC voltage, and a DC convertor (not shown in FIG. 4) for converting the first DC voltage to the above-described 12V voltage. The cellular phone 24 includes a convertor 26, a control unit 28, and a battery management unit 30. The convertor 26 is for converting the 12V voltage into a 5V voltage, and outputting the 5V voltage to the battery management unit 30 and the control unit 28. The battery management unit 30 is for converting the 5V voltage into a predetermined voltage to recharge the rechargeable battery 32, wherein the predetermined voltage is in a range from 3V to 4.2V. The control unit 28 is for converting the 5V voltage into several different operating voltages (e.g., a 1.2V voltage, a 1.8V voltage, etc.) to power operating units in the cellular phone 24.

A disadvantage in the above described battery charging system 20 is that there are two convertors: the DC convertor in the AC adapter 22 and the convertor 26 in the cellular phone 24. Another disadvantage is that the output of the AC adapter 22 is fixed and is much higher than the above-described predetermined voltage and the operating voltage. Due to these disadvantages, the battery charging system 20 is bulky, and expensive, and consumes power inefficiently.

### SUMMARY OF THE INVENTION

A battery charging system for receiving an AC voltage for recharging a rechargeable battery is provided herein. The battery charging system includes an adapter for rectifying an AC voltage into a first DC voltage; a controller for receiving a battery voltage of a rechargeable battery and outputting a control signal; and a DC switching convertor for converting the first DC voltage into a second DC voltage to recharge the rechargeable battery according to the control signal, wherein the second DC voltage changes according to the battery voltage. A battery charging method is also provided.

Other systems, methods, features, and advantages of the present charging system and method will become apparent to one with ordinary skill in the art upon examination of the following drawings and detailed description. It is intended that all such additional systems, methods, features, and advantages be included within this description, be within the scope of the present system, and be protected by the accompanying claims.

### BRIEF DESCRIPTION OF THE DRAWINGS

Many aspects of the present charging system and method can be better understood with reference to the following drawings. The components in the drawings are not necessarily to scale, emphasis instead being placed upon clearly illustrating the principles of the present circuit. Further, in the drawings, like reference numerals designate the same parts throughout the several views.

FIG. 1 illustrates a block diagram showing a battery charging system 10 in accordance with an aspect of the present invention.

FIG. 2 illustrates a block diagram showing a charging device 80 in accordance with an aspect of the present invention.

FIG. 3 illustrates a flowchart 1000 of an exemplary process of a charging method in accordance with an aspect of the present invention

FIG. 4. illustrates a conventional battery charging system 20.

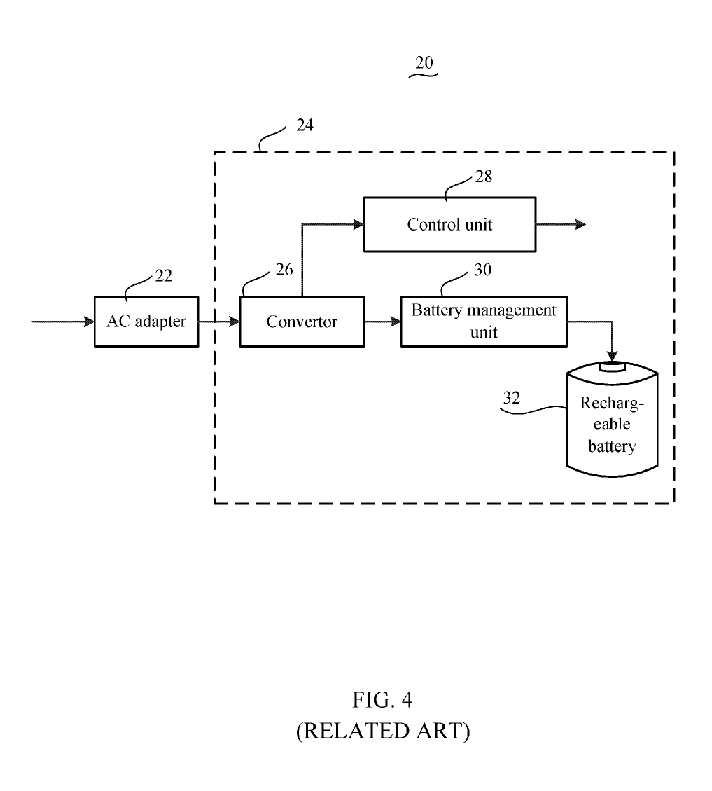

### DETAILED DESCRIPTION OF THE INVENTION

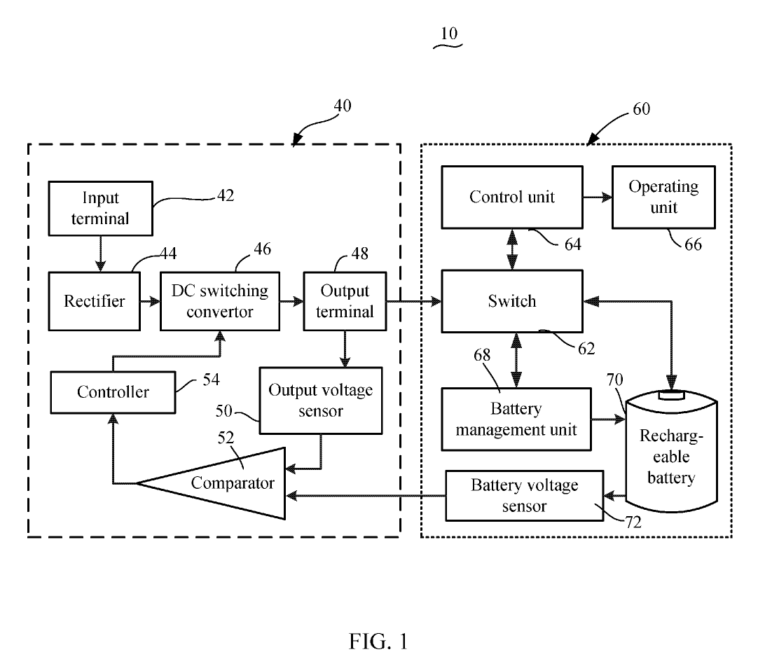

FIG. 1 illustrates a block diagram showing a battery charging system 10 including an adapter 40 and an electronic device 60 with a rechargeable battery 70 in a first preferred embodiment of the invention. The adapter 40 is for converting an alternating current (AC) voltage into a first direct current (DC) voltage, and then converting the first DC voltage to a second DC voltage according to a battery voltage of the electronic device 60. The electronic device 60 is for receiving the second DC voltage to recharge the rechargeable battery 70.

The adapter 40 includes an input terminal 42, a rectifier 44, a DC switching convertor 46, an output terminal 48, an output voltage sensor 50, a comparator 52, and a controller 54. The input terminal 42 is for receiving and transmitting the AC voltage to the rectifier 44. The rectifier 44 is for rectifying the AC voltage into a first DC voltage. The DC switching convertor 46 is for converting the first DC voltage into the second DC voltage according to a control signal received from the controller 54. The output terminal 48 is for transmitting the second DC voltage to the electronic device 60. The output voltage sensor 50 is for detecting and transmitting the second DC voltage to the comparator 52. The comparator 52 is for comparing the second DC voltage with the battery voltage received from the electronic device 60, and outputting a difference signal to the controller 54. The controller 54 is for generating the control signal according to the difference signal.

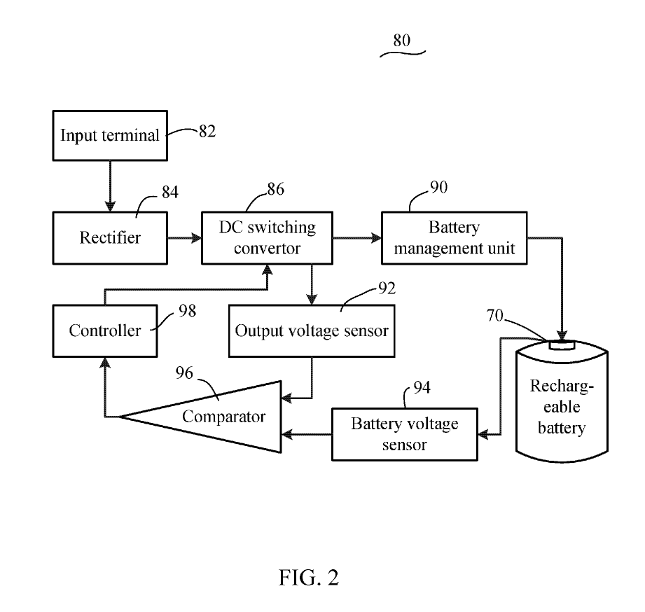

The input terminal 42 may be a single-phase power plug. The AC voltage may be received from an AC power source (not shown in FIG. 2), such as that found in conventional 220 volts (V) AC lines. The rectifier 44 may be a full bridge rectifier. The output voltage sensor 50 may be a resistor or a lead. The comparator 52 may be a voltage comparator. The controller 54 is preferably a pulse-width modulator, which outputs a pulse signal according to the difference signal. The pulse signal is used for controlling a switch-on time and a switch-off time of a switch (not shown in FIG. 2) of the DC switching convertor 46, thus, adjusting the second DC voltage according to the battery voltage of the rechargeable battery 70. The second DC voltage is preferably always 0.5V higher than the battery voltage of the rechargeable battery 70.

The electronic device 60 includes a switch 62, a control unit 64, an operating unit 66, a battery management unit 68, the rechargeable battery 70, and a battery voltage sensor 72. The switch 62 is connected to the output terminal 48 of the adapter 40, the control unit 64, the battery management unit 68, and the rechargeable battery 70. The switch 62 is for switching power supply modes of the electronic device 60. The power supply modes include an external power supply mode and a battery power supply mode. The control unit 64 is for controlling the switch 62 to switch the power supply modes. The control unit 64 is further used for converting the second DC voltage or the battery voltage received from the switch 62 into different operating voltages to power the operating unit 66 correspondingly. The battery management unit 68 is for receiving the second DC voltage from the switch 62, and converting the second DC voltage into a predetermined voltage (in other words, a third DC voltage) to recharge the rechargeable battery 70. The battery management unit 68 can also monitor a voltage, current, and temperature of the rechargeable battery 70. The battery voltage sensor 72 is for detecting the battery voltage of the rechargeable battery 70, and outputting the battery voltage to the adapter 40.

In the external power supply mode, the switch 62 transmits the second DC voltage to the control unit 64 and the battery management unit 68 (when the rechargeable battery 70 is inserted in the electronic device 60). In the battery power supply mode, the switch 62 transmits the battery voltage of the rechargeable battery 70 to the control unit 64. The operating unit 66 may include a liquid crystal display (LCD) driver, a storage circuit, a keyboard circuit, etc. The rechargeable battery 70 is preferably a Li-ion rechargeable battery, and is removable from the electronic device 60. The rechargeable battery 70 may be, alternatively, a Nickel-cadmium battery or a Nickel-hydrogen battery. The battery voltage sensor 72 may be a resistor or a lead.

It can be easily understood that the battery voltage changes during the charging and discharging of the rechargeable battery 70, so does the difference signal generated by the comparator 52 and the control signal generated by the controller 54. As a result, the second DC voltage is adjusted according to the battery voltage. As described above, the second DC voltage is preferably always 0.5V higher than the battery voltage. Furthermore, there is only one convertor (the DC switching convertor 46) in the battery charging system 10. Consequently, an operating efficiency of the battery charging system 10 is improved, while the power loss of the battery charging system 10 is reduced, and a cost and size of the same is reduced too.

In a second preferred embodiment, the rechargeable battery 70 can also be recharged independently of the electronic device 60. In other words, a system to recharge the battery when the battery is removed from the electronic device, such as the battery charging device 80 illustrated in FIG. 2. The charging device 80 includes an input terminal 82, a rectifier 84, a DC switching convertor 86, a battery management unit 90, an output voltage sensor 92, a battery voltage sensor 94, a comparator 96, and a controller 98.

The structures and principles of the input terminal 82, the rectifier 84, the DC switching convertor 86, the battery management unit 90, the output voltage sensor 92, the battery voltage sensor 94, the comparator 96, and the controller 98 of the second preferred embodiment are similar to the input terminal 42, the rectifier 44, the DC switching convertor 46, the battery management unit 68, the output voltage sensor 50, the battery voltage sensor 72, the comparator 52, and the controller 54 of the first preferred embodiment. The differences between the first and second preferred embodiment are that the battery management unit 90 and the battery voltage sensor 94 are configured in the charging device 80, and the battery management unit 90 is directly connected to the DC switching convertor 86.

In other embodiments, a battery charging system does not include the output voltage sensor 92 nor the comparator 96. The battery voltage sensor 94 directly transmits the battery voltage of the rechargeable battery 70 to the controller 98. The controller 98 outputs the control signal to the DC switching convertor 86 according to the battery voltage, adjusting the second DC voltage of the DC switching convertor 86 according to the battery voltage.

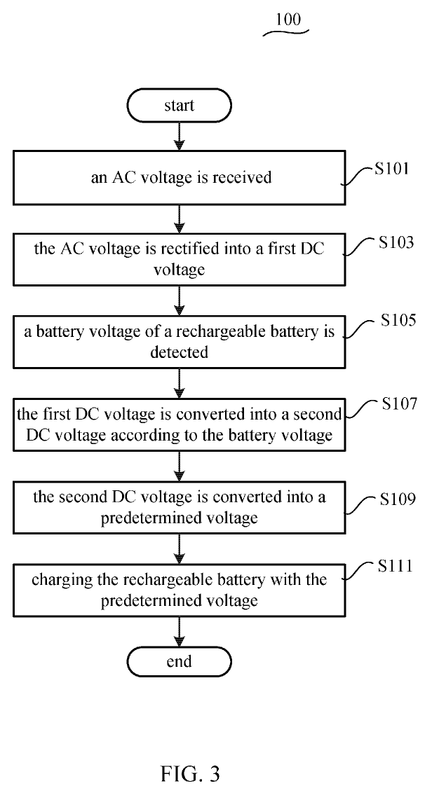

Referring to FIG. 3, a flow chart 100 for a charging method is shown. The charging method includes the following steps. In step S101, the AC voltage is received via the input terminal 42.

In step S103, the AC voltage is rectified into the first DC voltage.

In step S105, the battery voltage of the rechargeable battery 70 is detected (via a resistor for example).

In step S107, the first DC voltage is converted into the second DC voltage according to the battery voltage of the rechargeable battery 70. As a result, the second DC voltage changes according to the battery voltage.

In step S109, the second DC voltage is converted into the predetermined voltage.

In step S111, charging the rechargeable battery 70 with the predetermined voltage.

In other embodiments, the charging method 100 may also include the following steps: generating the difference signal by comparing the second DC voltage with the battery voltage; converting the first DC voltage into the second DC voltage according to the difference signal, thus, adjusting the second DC voltage according to the battery voltage.

Once the above described charging method 100 is put into practice, the operating efficiency of the battery charging device 10 will be improved, while the power loss of the battery charging device 100 will be reduced.

It should be emphasized that the above-described preferred embodiment, is merely a possible example of implementation of the principles of the invention, and is merely set forth for a clear understanding of the principles of the invention. Many variations and modifications may be made to the above-described embodiment of the invention without departing substantially from the spirit and principles of the invention. All such modifications and variations are intended to be included herein within the scope of this disclosure and the present invention and be protected by the following claims.

What is claimed is:

1. A battery charging system, comprising:
an adapter for rectifying an AC voltage into a first DC voltage;
a controller for receiving a battery voltage of a rechargeable battery and outputting a control signal; and
a DC switching convertor for converting the first DC voltage into a second DC voltage according to the control signal, wherein the second DC voltage changes according to the battery voltage, and the second DC voltage is for charging the rechargeable battery.

2. The battery charging system according to claim 1, further comprising a battery voltage sensor for detecting the battery voltage and transmitting the battery voltage to the controller.

3. The battery charging system according to claim 1, further comprising a comparator for outputting a difference signal to the controller by comparing the second DC voltage with the battery voltage.

4. The battery charging system according to claim 3, further comprising a battery voltage sensor for detecting the battery voltage of the rechargeable battery and transmitting the battery voltage to the comparator.

5. The battery charging system according to claim 3, further comprising an output voltage sensor for detecting the second DC voltage and transmitting the second DC voltage to the comparator.

6. The battery charging system according to claim 1, further comprising a battery management unit for converting the second DC voltage into a third DC voltage to recharge the rechargeable battery.

7. A battery charging system for charging a rechargeable battery, comprising:
an adapter for receiving an AC voltage and outputting a first DC voltage;
a controller for receiving a battery voltage of the rechargeable battery and outputting a control signal; and
a DC switching convertor for receiving the first DC voltage and the control signal, and
outputting a second DC voltage according to the control signal; wherein the second DC voltage changes according to the battery voltage, and the second DC voltage is for charging the rechargeable battery.

8. The battery charging system according to claim 7, further comprising a comparator for outputting a difference signal to the controller by comparing the second DC voltage with the battery voltage.

9. The battery charging system according to claim 8, further comprising a battery voltage sensor for detecting the battery voltage and transmitting the battery voltage to the comparator.

10. The battery charging system according to claim 8, further comprising an output voltage sensor for detecting the second DC voltage and transmitting the second DC voltage to the comparator.

11. The battery charging system according to claim 7, further comprising a battery management unit for converting the second DC voltage into a third DC voltage to recharge the rechargeable battery.

12. A battery charging method, comprising:
receiving an AC voltage;
rectifying the AC voltage into a first DC voltage;
detecting a battery voltage of a rechargeable battery;
converting the first DC voltage into a second DC voltage according to the battery voltage,
wherein the second DC voltage changes according to the battery voltage; and
charging the rechargeable battery with the second DC voltage.

13. The battery charging method according to claim 12, further comprising:
converting the second DC voltage into a third DC voltage;
charging the rechargeable battery with the third DC voltage.

14. The battery charging method according to claim 12, further comprising:
generating a difference signal by comparing the second DC voltage with the battery voltage;
converting the first DC voltage into the second DC voltage according to the difference signal,
wherein the second DC voltage changes according to the battery voltage.
